(19) United States
(12) Patent Application Publication
(10) Pub. No.: US 2023/0199819 A1
(43) Pub. Date: Jun. 22, 2023

(54) COMMUNICATION TECHNIQUES FOR SIDELINK TRANSMISSION IN MILLIMETER-WAVE DOMAIN

(71) Applicant: Samsung Electronics Co., Ltd., Gyeonggi-do (KR)

(72) Inventors: Yaser Mohamed Mostafa Kamal FOUAD, San Diego, CA (US); Philippe Jean SARTORI, Naperville, IL (US); Liang HU, San Diego, CA (US)

(21) Appl. No.: 18/071,297

(22) Filed: Nov. 29, 2022

Related U.S. Application Data
(60) Provisional application No. 63/290,252, filed on Dec. 16, 2021.

(51) Int. Cl. H04W 72/541; H04W 72/25; H04W 72/0446; H04W 72/56

(52) U.S. Cl. CPC H04W 72/541; H04W 72/25; H04W 72/0446; H04W 72/56

(57) ABSTRACT

Disclosed is a method including identifying, for a transmission between a user equipment (UE) and one or more neighboring UEs, one or more interfering UEs of the one or more neighboring UEs by determining potential collisions between candidate resources identified by the UE and resources selected by the one or more neighboring UEs based on beam information, location information of the UE, measured signal strength, and resource reservation information, and excluding resources reserved by the one or more interfering UEs from a resource selection window.

### CROSS-REFERENCE TO RELATED APPLICATION(S)

This application is based on and claims priority under 35 U.S.C. § 119(e) to U.S. Provisional Application Ser. No. 63/290,252, which was filed in the U.S. Patent and Trademark Office on Dec. 16, 2021, the disclosure of which is incorporated herein by reference in its entirety as if fully set forth herein.

### TECHNICAL FIELD

The disclosure relates generally to wireless communication systems. More particularly, the subject matter disclosed herein relates to improvements to communication techniques for sidelink (SL) transmission in a millimeter wave (mmWave) domain in wireless communication systems.

### SUMMARY

It is anticipated that new radio (NR) SL will significantly expand over the next decade and enable the introduction of numerous applications due to a distributed design that enables in-coverage and out-of-coverage support, and short distance links that require relatively low transmit power. However, to realize the potential capabilities of SL communications, such systems should support high data rate communications with high reliability. Thus, several proposals have been considered for NR release 18 (Rel-18) SL design, including expansion of the available bandwidth for SL communication by supporting frequency range 2 (FR2) communication.

Despite advantages of using FR2 for SL communication in expanding the available bandwidth and subsequently the data rate, a major drawback is the need for beam forming. Unlike direct link, high mobility is involved in some SL communication instances such as vehicle to everything (V2X) systems whereby both a transmitter and a receiver(s) are expected to be mobile. In addition, there is a higher probability of line-of-sight obstruction due to directional transmissions in FR2, which necessitates beam pairing techniques between transmission (Tx) and reception (Rx) user equipments (UEs). Direct link beam sweeping techniques are inapplicable in SL due to varying fundamentals of SL communications. In particular, a synchronization source which sends synchronization signal blocks (SSBs)) is not necessarily involved in the communication, such that use of the SSBs does not occur in coarse beam sweeping. Hence, there is a need in the art for more efficient techniques to obtain an initial beam direction.

The present disclosure is related to an SL system, whereby Tx and Rx UEs are not actively engaged in SL communication and should perform initial beam pairing to communicate in FR2 since SL discovery and beam selection have yet to be performed. Subsequently, the disclosure provides a procedure to efficiently perform beam sweeping in order to obtain an initial beam pair. In addition, the disclosure provides updates to the Mode 2 resource selection mechanism of SL in order to incorporate the impact of directivity and subsequently improve system resource utilization.

The prior art discloses initial beam acquisition in cellular systems for a direct link (i.e., a Uu link).

In NR, beam management is defined as a set of L1/L2 procedures to acquire and maintain a set of transmit reception points (TRPs) and/or UE beams that can be used for downlink (DL) and uplink (UL) Tx/Rx, which include beam determination for TRPs or a UE to select Tx/Rx beams, beam measurement for TRPs or a UE to measure characteristics of received beamformed signals, beam reporting for a UE to report information of beamformed signals based on beam measurement, and beam sweeping for covering a spatial area with beams transmitted and/or received during a time interval.

Beam management can be hierarchically performed, whereby an initial acquisition identifies a relatively wide beam while the subsequent beam refinement identifies a more directional and higher gain beam. In the DL direction, the UE can complete beam selection based upon the transmission of synchronization signal/physical broadcast channel (SS/PBCH) blocks and channel state information (CSI) reference signals (CSI-RSs). Beamforming coefficients applied to the set of SS/PBCH blocks can be used to generate relatively wide beams for initial acquisition. In contrast, beamforming coefficients applied to the set of CSI-RS resources can be used to generate more directional beams for subsequent beam refinement.

A UE in radio resource control (RRC) idle mode establishes UL and DL beam pairs during the random access (RA) procedure. At this point, the UE is measuring the reference signal received power (RSRP) from the set of SS/PBCH blocks for the purpose of cell reselection. In addition, the UE has already acquired the set of system information blocks (SIBs) and therefore, already knows the association between the set of SS/PBCH blocks and the set of physical RA channel (PRACH) preambles.

The set of SS/PBCH blocks are time multiplexed with a maximum of 2 SS/PBCH blocks per slot. The base station applies a different set of beamforming coefficients to each SS/PBCH block to generate the set of 8 beams. When initiating the transition to RRC connected mode, the UE identifies the best SS/PBCH block and selects a contention-based PRACH preamble corresponding to that SS/PBCH block. Thus, the UE knows the optimal DL beam at the base station and the optimal DL beam/antenna panel at the UE, if supported, based on the measured RSRP. Subsequently, the UE assumes UL/DL beam correspondence so the selected DL beam pair is also adopted as the selected UL beam pair. The UE then proceeds to transmit the selected PRACH preamble using the appropriate RA occasion. Upon reception of the PRACH preamble, the base station becomes aware of the SS/PBCH block selected by the UE and thus, has knowledge of the beam to be used for subsequent DL transmission and UL reception.

Once a UE has entered RRC connected mode, it is possible to initiate a beam refinement procedure to select beams which are more directional and have higher gain.

The CSI-RS can be used to support the beam refinement procedure. For example, a set of 4 CSI-RS resources can be associated with each SS/PBCH block. The base station can apply a different set of beamforming coefficients to each CSI-RS resource to generate 4 directional beams per SS/PBCH block. Subsequently, the UE can perform the necessary measurements based on the transmitted CSI-RSs and accordingly report the best beam index.

In resource allocation Mode 2, which is the resource selection procedure in NR release 16 (Rel-16) NR V2X, the higher layer can request the UE to determine a subset of resources from which the higher layer will select resources for physical SL shared channel (PSSCH)/physical SL control channel (PSCCH) transmission. In slot n, to trigger this PSSCH/PSCCH transmission, the higher layer provides the resource pool from which the resources are to be reported, L1 priority, prio_{TX}, the remaining packet delay budget, the number of sub-channels to be used for the PSSCH/PSCCH transmission in a slot, L_{subCH}, and the resource reservation interval, p_{rsvp_TX}, in units of ms.

FIG. 1 illustrates a Mode 2 resource selection, according to the prior art. In step 101, the selection window is set, i.e., t2min_SelectionWindow: internal parameter T₂ₘᵢₙ is set to the corresponding value from higher layer parameter t2 min_SelectionWindow for the given priority value of prio_{TX}. A candidate single-slot resource for transmission R_{x,y} is defined as a set of L_{subCH} contiguous sub-channels with sub-channel x+j in slot t_{y}^{SL} where j=0, . . . , L_{subCH}—1. The UE presumes that any set of L_{subCH} contiguous sub-channels included in the corresponding resource pool within the time interval [n+T₁, n+T₂] corresponds to one candidate single-slot resource, where selection of T₁ is up to UE implementation under 0≤T₁≤T_{proc,1}, and where T_{proc,1} is to be determined (TBD). If T₂ₘᵢₙ is less than the remaining packet delay budget (in slots) then T₂ is based on UE implementation subject to T₂ₘᵢₙ≤T₂≤remaining packet budget (in slots); otherwise, T₂ is set to the remaining packet delay budget (in slots). The total number of candidate single-slot resources is denoted by Mₜₒₜₐₗ.

In step 102, the sensing window is set and all of the slots are monitored by decoding the PSCCH and measuring the PSRP. Specifically, RSforSensing indicates whether the UE uses the PSSCH-RSRP or PSCCH-RSRP measurement, as defined in TS 38.214 subclause 8.4.2.1. reservationPeriodAllowed t0_SensingWindow. Internal parameter T₀ is defined as the number of slots corresponding to T₀ SensingWindow ms. The sensing window is defined by the range of slots [n−T₀,n−T_{proc,0}) where T₀ is defined above and T_{proc,0} is TBD. The UE monitors slots which can belong to an SL resource pool within the sensing window except for those in which its own transmissions occur. The UE performs the following steps based on the decoded PSCCH and the measured RSRP in these slots.

In step 103, a threshold SL-ThresRSRP_pi_pj is set depending on the priority value. This higher layer parameter provides an RSRP threshold for each combination (pᵢ, pⱼ), where pᵢ is the value of the priority field in received SL control information (SCI) format 0-1 and pⱼ is the priority of the transmission of the UE selecting resources. For a given invocation of this procedure, pⱼ=prio_{TX}. The internal parameter Th(pᵢ) is set to the corresponding value from higher layer parameter SL-ThresRSRP_pi_pj for pⱼ equal to the given value of prio_{TX} and each priority value pᵢ.

The resource reservation interval, P_{rsvp_TX}, if provided, is converted from units of ms to units of logical slots, resulting in P_{rsvp_TX}.

Specifically,

(t₀^{SL}, t₁^{SL}, t₂^{SL}, . . . ) denotes the set of slots which can belong to an SL resource pool and is predefined.

In step 104, set S_{A} is initialized to the set of all the candidate single-slot resources.

In step 105, the UE excludes any candidate single-slot resource R_{x,y} from the set S_{A} if the UE has not monitored slot tₘ^{SL} in step 102. For any periodicity value allowed by the higher layer parameter reservationPeriodAllowed and a hypothetical SCI format 0-1 received in slot tₘ^{SL} with the resource reservation period field set to that periodicity value and indicating all subchannels of the resource pool in this slot, condition c in step VI would be met.

In step 106, the UE excludes any candidate single-slot resource R_{x,y} from the set S_{A} if the UE receives an SCI format 0-1 in slot tₘ^{SL}, the resource reservation period field and priority field in the received SCI format 0-1 indicate the values P_{rsvp_RX} and prio_{RX}, respectively, according to set S_{A} in step 104. and the RSRP measurement performed according to received SCI format 0-1 is greater than Th(prio_{Rx}). The SCI format received in slot tₘ^{SL} the same SCI format which, if the resource reservation period field is present in the received SCI format 0-1, is assumed to be received in slot(s) t_{m+q×P′}_{_{rsvp_RX}}^{SL} determines, based on step 104, the set of resource blocks and slots which overlaps R_{x,y+j×P′}_{_{rsvp_TX}} for q=1, 2, . . . , Q and j=0, 1, . . . , Cᵣₑₛₑₗ−1. Here, P′_{rsvp_RX} is P_{rsvp_RX} converted to units of logical slots,

$$Q = ⌈ \frac{{T}_{s c a l}}{{P}_{rsνp\_RX}} ⌉$$

IF P_{rsvp_RX}<T_{scal} and n′−m≤P′_{rsvp_RX}, where t_{n′}^{SL}=n if slot n belongs to set (t₀^{SL}, t₁^{SL}, . . . , t_{Tmax}^{SL}), otherwise slot tₙ^{SL}, is the first slot after slot t_{n′}^{SL} belonging to set (t₀^{SL}, t₁^{SL}, . . . , t_{Tmax}^{SL}); otherwise Q=1.T_{scal} is TBD.

In step 107, it is determined whether the number of candidate single-slot resources remaining in set S_{A} is less than 0.2·Mₜₒₜₐₗ. If so, then in step 108, Th(pᵢ) is increased by three decibels (3 dB) for each priority value Th(pᵢ) and the procedure returns to step 104. If the number of candidate single-slot resources remaining in set S_{A} is greater than 0.2·Mₜₒₜₐₗ, then in step 109 the UE reports the remainder of set S_{A} to higher layers which randomly select a candidate resource for transmission.

As previously stated, the currently defined Mode 2 resource selection procedure does not consider antenna gain. While this is plausible in frequency range 1 (FR1) communication where the antenna gains are minimal, such as 3 dBi, communications in FR2 rely on highly directional antennas, causing a need in the art for a modification of the Mode 2 resource selection procedure for FR2.

In addition, the UEs in FR2 SL communication should be able to perform initial beam pairing for efficient communication. In a Uu link, the initial beam sweeping is based on SSB transmissions from the base station which are detected by the served UEs. Such a solution is not possible in SL, given that the UE does not transmit the SL SSB. Even if an SL SSB (S-SSB) is received, the receiving UE in the prior art is unaware of the sending UE. As such, there is a need in the art for an initial beam acquisition technique that does not rely on SSBs for SL communications over FR2.

The present disclosure has been made to address at least the above-mentioned problems and/or disadvantages and to provide at least the advantages described below.

Accordingly, an aspect of the present disclosure is to provide techniques enabling fast, efficient, and reliable initial beam pairing in a high mobility environment, such as V2X systems.

Another aspect of the present disclosure is to provide a method and apparatus for achieving an initial beam acquisition while assuming that an S-SSB cannot be used for the initial beam acquisition.

Another aspect of the disclosure is to provide an update to the Mode 2 resource selection NR release 17 (Rel-17) SL procedure to enhance resource utilization by incorporating beam directivity to enable neighboring UEs to reuse the same resource when they do not interfere with each other.

The above approaches improve on previous methods because they provide an initial beam acquisition technique that does not rely on SSBs for SL communications over FR2. In addition, the above approaches are suited for FR2 since they incorporate beam directivity in beam selection, unlike the prior art which is suited for FR1 since there is no directivity or beam information that is considered in FR1.

In an embodiment, a method includes identifying, for a transmission between a UE and one or more neighboring UEs, one or more interfering UEs of the one or more neighboring UEs by determining potential collisions between candidate resources identified by the UE and resources selected by the one or more neighboring UEs based on beam information, location information of the UE, measured signal strength, and resource reservation information, and excluding resources reserved by the one or more interfering UEs from a resource selection window.

In an embodiment, a UE includes at least one processor, and at least one memory operatively connected with the at least one processor, the at least one memory storing instructions, which when executed, instruct the at least one processor to perform a method by identifying, for a transmission between a UE and one or more neighboring UEs, one or more interfering UEs of the one or more neighboring UEs by determining potential collisions between candidate resources identified by the UE and resources selected by the one or more neighboring UEs based on beam information, location information of the UE, measured signal strength, and resource reservation information, and excluding resources reserved by the one or more interfering UEs from a resource selection window.

### BRIEF DESCRIPTION OF THE DRAWINGS

In the following section, the aspects of the subject matter disclosed herein will be described with reference to exemplary embodiments illustrated in the figures, in which:

FIG. 1 illustrates a Mode 2 resource selection, according to the prior art;

FIG. 2 illustrates non-interfering transmissions in FR2, according to an embodiment;

FIG. 3 illustrates a beam width indicated by an Tx UE, according to an embodiment;

FIG. 4 illustrates a method by a UE for selecting resources in FR2, according to an embodiment;

FIG. 5 illustrates how transmissions are declared as non-interfering, according to an embodiment;

FIG. 6 illustrates a two-step procedure for beam selection, according to an embodiment;

FIG. 7 illustrates an example of a zone partitioned into subzones, according to an embodiment; and

FIG. 8 is a block diagram of an electronic device in a network environment 800, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In NR SL, Mode 2 resource selection is used to identify future resource reservations by neighboring UEs so that the UE can select resources with minimal interference. This selection is performed by a two-step procedure in which the UE first performs sensing for a given duration to identify future resource reservations by neighbors within a resource selection window. Subsequently, the remaining resources within this window can be used as candidates for transmission. In contrast with FR1 in which all resource reservations are omnidirectional, the directivity of transmissions in FR2 is considered to improve the spectrum utilization. That is, a resource occupied by a neighboring UE may not interfere with a Tx UE transmission if their target UEs are in different directions.

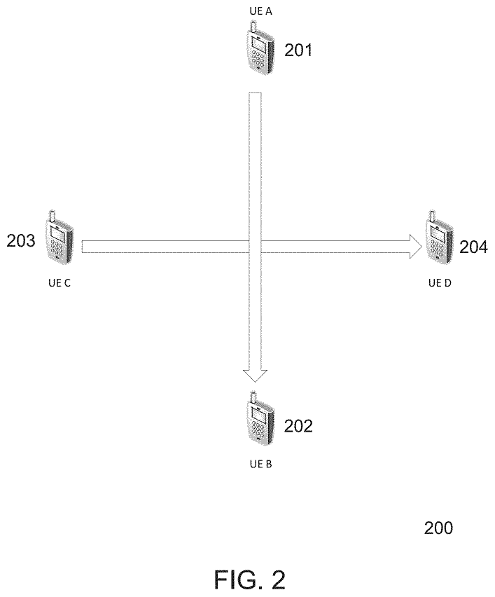

FIG. 2 illustrates non-interfering transmissions 200 in FR2, according to an embodiment.

As illustrated in FIG. 2, even if UE A 201 and UE C 203 use the same resource, these UEs will not interfere with one another as long as their transmissions are sufficiently directional (i.e., the transmission beams have a limited bandwidth and are not pointing towards one another). The same applies to UE B 202 and UE D 204.

This enables for better utilization of the system resources since these resources can be simultaneously used by multiple UEs. However, for this to be achieved, the following approaches are considered for a neighboring UE to identify whether a resource reservation would cause interference between the UEs.

In a first approach, the locations of the Tx and Rx UEs are not indicated in the SCI or as a medium access control (MAC) control element (CE) along with the transmissions. In this case, neighboring UEs must rely on previous knowledge of UEs locations obtained through other means, such as basic safety messages.

In a second approach, the location of the Tx UE is indicated in the SCI (1^{st} or 2^{nd} stage) along with the selected direction for transmission. For example, a Tx UE can indicate that its location is zone X and that it is transmitting at an angle of 90 degrees for the current and future resource reservation. Alternatively, the direction of transmission can be obtained by the Rx UE by estimating the angle of arrival or the target UE location for the transmission.

In a third approach, the locations of both the Tx and Rx UEs are included in the SCI (1^{st} or 2^{nd}) or in a MAC CE. Thus, the neighboring UEs can identify the direction of current and future resource reservations.

To reduce the signaling overhead, a table including a set of possible directions can be configured per resource pool. Subsequently, the Tx UE will only need to indicate the index that refers to the angle of its transmission. It is noted that the resource reuse feature can be enabled or disabled per resource pool based on priority.

As previously explained, the following benefits are derived from the embodiment in FIG. 2. The directivity of transmissions in FR2 is considered to improve the resource utilization by enabling UEs to transmit on resources occupied by their neighboring UEs if no interference is expected due to directivity. The sensing UEs can identify the direction of the transmission either explicitly (e.g., by an explicit indication provided by the Tx UE) or implicitly (e.g., by using pre-known locations of Tx and Rx UEs or by estimating the angle of arrival). The indication of transmission direction can be sent in the 1^{st} or 2^{nd} stage SCI or by a MAC CE. To reduce the signaling overhead, the direction of the transmission can be indicated as an index of a table that is pre-configured per resource pool.

To improve collision avoidance and increase the instances of resource reuse, the Tx UE can also indicate the beam width used for its transmission to neighboring UEs when resource reuse is allowed. This can significantly assist in identifying whether an interference should be expected when the same resource is reused by a neighboring UE. This indication can be either sent in the 1^{st} or 2^{nd} stage SCI or as a MAC CE in the PSSCH. In addition, a pre-configured beam width can be used when the indication is not provided, whereby this beam width is configured per resource pool per priority. The beam to be used may be referenced by an index. When the beam width is indicated, a coarse indication can be used to reduce the overhead.

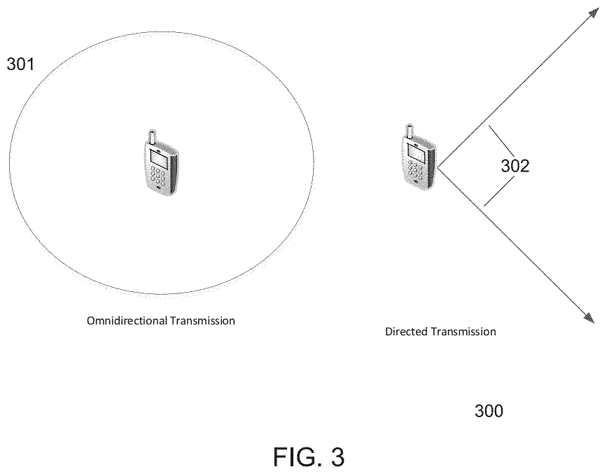

FIG. 3 illustrates a beam width indicated by a Tx UE, according to an embodiment. In FIG. 3, a 1-bit field is used to indicate whether the transmission is using either a Quasi-omnidirectional beam 301 or a 120 degree angle beam 302. For example, the Quasi-omnidirectional beam 301 can be used in a street intersection to deliver a safety message to all neighboring UEs such that the message does not interfere with another transmission of a neighboring UE.

In summary, the following benefits are derived from the embodiment in FIG. 3. A UE can indicate the used beam width of its transmission to a neighboring UE to reduce the chances of collision if resource reuse is enabled, and the indication of the beam width can be carried in a 1^{st} or 2^{nd} stage SCI or as a MAC CE in the PSSCH.

Once the location of a neighboring UE, the direction of its intended transmission, and the beam width are obtained, a neighboring UE intending to transmit can assess whether a resource is occupied, and accordingly, elect to transmit on the same resource or select a different resource. This can be done by updating the Mode 2 resource selection to consider both the measured RSRP and the intended transmission directions, when excluding resources.

In particular, the Mode 2 resource selection mechanism is updated as follows. A candidate single-slot resource for transmission R_{x,y} is defined as a set of L_{subCH} contiguous sub-channels with sub-channel x+j in slot t_{y}^{SL} where j=0, . . . , L_{subCH}−1. The UE presumes that any set of L_{subCH} contiguous sub-channels included in the corresponding resource pool within the time interval [n+T₁, n+T₂] correspond to one candidate single-slot resource, where selection of T₁ is up to UE implementation under 0≤T₁≤T_{proc,1}; if T₂,n is less than the remaining packet delay budget (in slots) then T₂ is up to UE implementation subject to T₂ₘᵢₙ≤T₂≤remaining packet budget (in slots); otherwise, T₂ is set to the remaining packet delay budget (in slots). The total number of candidate single-slot resources is denoted by Mₜ. H is the location of the target Rx UE to which the TB that triggered the resource selection will be transmitted. K is the location of the Rx UE to which the neighboring Tx UE is transmitting.

The sensing window is defined by the range of slots [n−T₀, n−T_{proc,0}) where T₀ is defined in the above manner. The UE monitors slots belonging to an SL resource pool within the sensing window except for those in which its own transmissions occur. The UE shall perform the following steps based on the decoded PSCCH and the measured RSRP in these slots.

The internal parameter Th(pᵢ) is set to the corresponding value from a higher layer parameter.

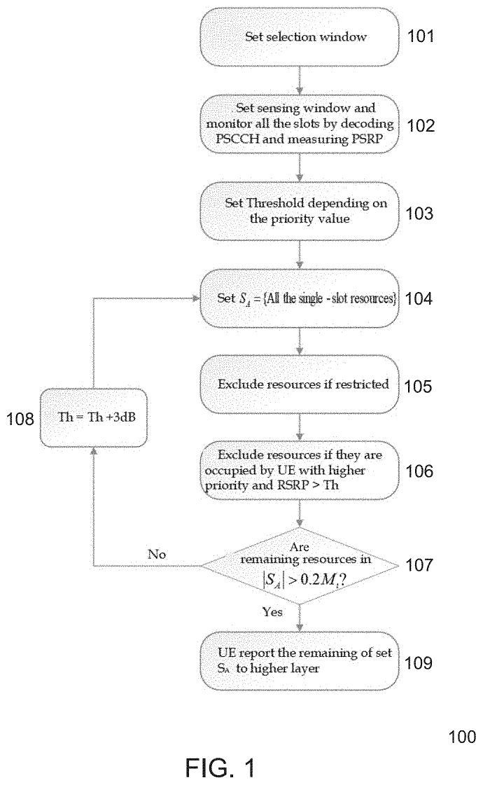

The set S_{A} is initialized to the set of all the candidate single-slot resources. The UE excludes any candidate single-slot resource R_{x,y} from the set S_{A} if the following conditions are met. The UE has not monitored slot tₘ^{SL} in step 102 as FIG. 1. For any periodicity value allowed by the higher layer parameter reservationPeriodAllowed and a hypothetical SCI format 0-1 received in slot tₘ^{SL} with the resource reservation period field set to the allowed periodicity value and indicating all subchannels of the resource pool in this slot, a condition described above in step 106 in FIG. 1 would be met. That is, the UE excludes any candidate single-slot resource R_{x,y} from the set S_{A} if the UE receives an SCI format 0-1 in slot tₘ^{SL}, and the resource reservation period field, if present, and priority field in the received SCI format 0-1 indicate the values P_{rsvp_RX} and prio_{Rx}, respectively, and the RSRP measurement performed based on received SCI format 0-1 is greater than Th(prio_{RX}). The SCI format received in slot tₘ^{SL} the same SCI format which, if the resource reservation period field is present in the received SCI format 0-1, is assumed to be received in slot(s) t and determines the set of resource blocks and slots which overlap with R_{x,y+j×P′}_{_{rsvp_TX}} for q=1, 2, . . . , Q and j=0, 1, . . . , Cᵣₑₛₑₗ−1, as previously described. Here, P′_{rsvp_RX} is P_{rsvp_RX} converted to units of logical slots,

$$Q = ⌈ \frac{{T}_{s c a l}}{{P}_{rsνp\_RX}} ⌉$$

if P_{rsvp_RX}<T_{scal} and n′−m≤P′_{rsvp_RX}, where tₙ^{SL}=n if slot n belongs to the set (t₀^{SL}, t₁^{SL}, . . . , t_{Tmax}^{SL}), otherwise, slot t_{n′}^{SL} is the first slot after slot n belonging to the set (t₀^{SL}, t₁^{SL}, . . . , t_{Tmax}^{SL}); otherwise, Q=1. T_{scal} is set to selection window size converted to units of milliseconds (msec). A beam (B₁) is constructed between the locations of the neighboring Tx and Rx UEs. The beam width used for B₁ is based on either the indication provided by the neighboring Tx UE or the resource pool pre-configuration dependent on the priority of the transmission (pⱼ). Similarly, a beam (B₂) is constructed between the Tx UE location and the target Rx UE location. The beam width used for B₂ is based on either the indication provided by higher layers or the resource pool pre-configuration dependent on the priority of the transmission (pₗ). If the beam B₁ covers the position H or the zone in which H is located or if the beam B₂ covers the position K or the zone in which K is located, the candidate single-slot resource R_{x,y} should be excluded. Otherwise, resource R_{x,y} is not excluded. If the number of candidate single-slot resources remaining in the set S_{A} is less than 0.2·Mₜₒₜₐₗ, then Th(pⱼ) is increased by 3 dB for each priority value Th(pᵢ) and step 104 in FIG. 1 is performed, whereby the UE reports the remainder of set S_{A} to higher layers, and according to the PRS configuration, the higher layer selects a candidate resource for PRS/CSI-RS for the SL positioning.

As described above, the Mode 2 resource selection procedure is updated to consider the transmission directivity when excluding resources from the resource selection window, a resource is considered as occupied only if either the constructed beam trajectory of the transmission between neighboring UEs covers the location of the targeted receiver of the TB that initiated the resource selection or if the constructed beam of the TB that initiated the resource selection covers the location of the targeted neighboring receiver, and the width of the constructed beam between the Tx and Rx UEs can be either indicated by the neighboring Tx UE or configured per resource pool and can be dependent on the transmission priority whereby higher priority would be associated with a wider beam to reduce the chances of other UEs reusing the same resource.

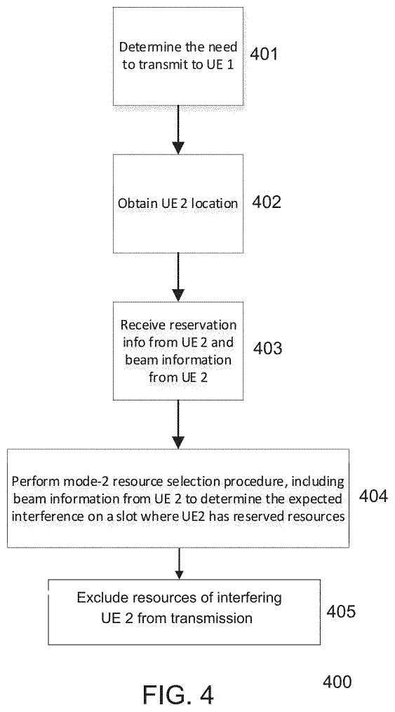

FIG. 4 illustrates a method 400 by a UE for selecting resources in FR2, according to an embodiment.

In step 401, a UE determines the need to transmit to UE 1 by performing sensing as currently defined in NR Rel-16 and NR Rel-17. In particular, the UE decodes the first stage SCI on the PSCCH, thereby enabling the UE to obtain reservation by UE 2 and other neighboring UEs. In step 402, the UE obtains the location of UE 2 from either the basic safety messages (sent on another carrier, such as in FR1), or as explained above, in the second stage SCI message UE beam information. The location of UE 2 can also be determined in step 402 using the above-described techniques. For example, a field in the first stage SCI may indicate the antenna characteristics (e.g., direction, attenuation, etc.).

In step 403, the UE uses the decoded first stage SCI on the PSCCH to obtain reservation and beam information from UE 2.

In step 404, the UE performs Mode 2 resource selection including beam information from UE 2 to estimate the expected interference on a slot where UE 2 has reserved resources. Specifically, the UE can select resources once it has obtained information about the location of UE 2 and all the UEs it monitored/identified during the sensing procedure. The updated Mode 2 procedure is used to consider the UE 2 location and antenna beam information to determine the interference level created by UE 2 from the perspective of the transmitting UE.

In step 405, the resources reserved by the interfering UE 2 are excluded from the transmission. That is, a UE can declare a resource as either occupied or unoccupied by relying only on the zone information. In particular, the UE uses the zone information of the neighboring Tx and Rx UEs, and accordingly, constructs a projection of the transmission. If this projection intersects with the zone of the intended Rx UE, the resource can be declared as occupied and is thereby excluded from the transmission. Alternatively, a UE can declare a resource as occupied if its targeted Rx UE and the targeted Rx UE by its neighboring UE both fall within the same zone without constructing any trajectories. For example, the zone can be indicated by an index referring to a set of locations pre-configured by RRC signaling. The resources are selected by determining whether an RSRP measurement performed on the reservation signal is greater than a threshold, as in Mode 2 selection described above in FIG. 1.

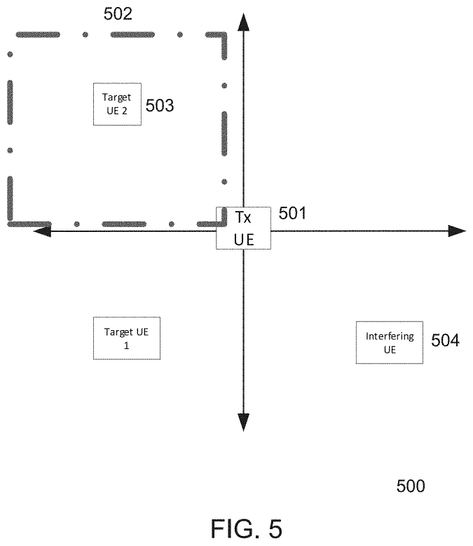

FIG. 5 illustrates how transmissions are declared as non-interfering 500, according to an embodiment. In FIG. 5, the zone indication is by an angular sector, as a two-bit bit field is used to indicate the quadrant in which the zone is viewed as being occupied.

In addition, for one or more UEs very close to the Tx UE 501 as determined by the RSRP measurement of the reservation signal, even if these UEs are not in the occupied zone, an interfering UE 504 could still produce significant interference on the Tx UE 501. Thus, an exclusion zone 502 is defined around the Tx UE 501. A UE anywhere in this exclusion zone, such as Target UE 2 503, needs to be included when determining interference. The exclusion zone 502 can be hard-coded or (pre-)configured by RRC signaling.

To reduce complexity, therefore, the exclusion of resources by the Mode 2 resource selection can rely on the zones in which the UEs reside rather than their actual locations.

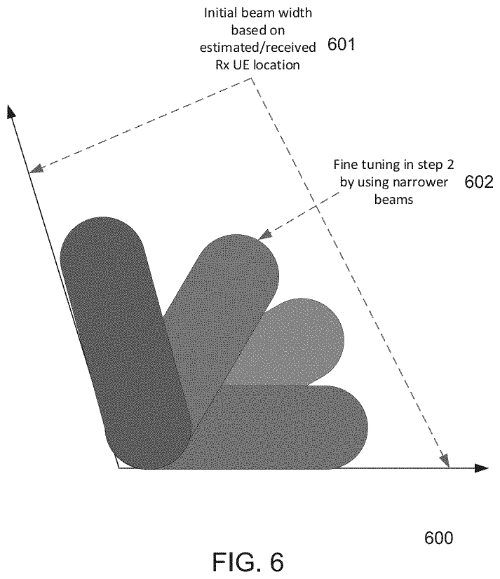

FIG. 6 illustrates a two-step procedure for beam selection 600, according to an embodiment.

Specifically, for UEs to be able to communicate using SL in FR2, the UEs should be able to direct their beams in the direction of the receiving UE for initial beam acquisition in FR2. To achieve this, a two-step beam selection process is disclosed in FIG. 6. In the first step 601, UEs achieve coarse beam steering by relying on wider beams, and in the second step 602, the UEs perform fine tuning to achieve better directivity and subsequently higher throughput and reliability. The first, wider beam needs to be quasi co-located (QCL)-ed with the narrow beams.

In particular, UEs can utilize the readily available locations of their target neighboring UEs for coarse beam selection. In V2X systems, vehicles are expected to periodically transmit their locations using basic safety messages for safety applications. Using this information, along with its own location, a UE can identify the relative location of neighboring UEs and perform the initial beam selection accordingly. Alternatively, the UE can rely on the zone information sent in the 2^{nd} stage SCI to obtain the relative locations of neighboring UEs with decreased accuracy.

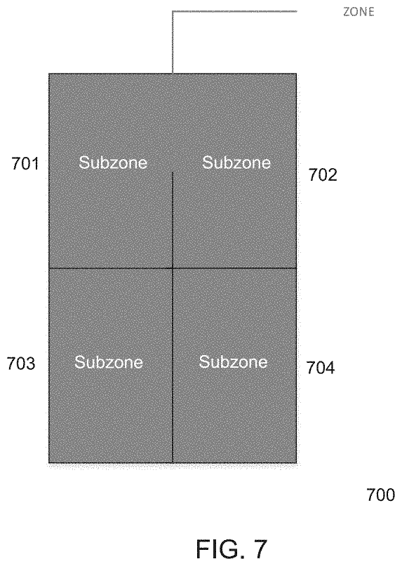

FIG. 7 illustrates an example of a zone 700 partitioned into subzones, according to an embodiment. The decreased accuracy described above is mitigated by introducing the subzones 701, 702, 703 and 704 in FIG. 7, whereby a UE indicates its location within the zone using a new parameter. Although four zones are illustrated in FIG. 7, the size of the subzone and the number of subzones per zone can be configured per resource pool. The indication of the subzone can be either added as a new field to the 2^{nd} stage SCI or as a MAC CE in the PSSCH and sent to neighboring UEs. Since the accuracy of the direction estimation may be decreased, wider beams are relied upon to be able to reach neighboring UEs and initiate the communication. The beam width can depend on one or more of the reliability of the location information, the relative speed of the transmission, the transmission priority, and the validity of the latest updated location information.

The selection of the first beam direction by the Tx UE can depend on the relative location of its Rx UE.

If a source UE is aware of the destination UE's location, the source UE is expected to send a first beam in a direction that covers the destination UE, which differs from the existing beamforming procedure for cellular, where the beam orientation follows a defined pattern, independently of where the source and destination are located.

While the concept of a zone has been defined in FAN1, it is noted that it would be undesirable to create smaller zones since these zones are already used for other purposes on the SL and are signaled in the 2^{nd} stage SCI. Thus, increasing the number of zones would increase the overhead for other purposes, which is why the disclosed subzones are beneficial.

In addition, a zone is defined by its coordinates in RRC signaling, while in contrast, a subzone does not need such signaling since it is automatically defined based on the zone.

That is, a rectangular zone 700 is automatically divided into four subzones 701, 702, 703 and 704 as shown in FIG. 7. Accordingly, the extension to a different number of subzones is simplified.

In addition to the location information contained in basic safety messages, additional physical (PHY) layer accessible location information can be sent in the 2^{nd} stage SCI or MAC CE (e.g., the zone field in the 2^{nd} stage SCI and subzone field either in the 2^{nd} stage SCI or as MAC CE) to facilitate the identification of the target UE location. This transmission can be periodically performed whereby the period can be configured per resource pool. Alternatively, the transmission can be sent in response to a request from a neighboring UE sent in FR1 (either in 1^{st} or 2^{nd} stage SCI or as a MAC CE) since the direction of the Rx UE may be unknown.

For example, the 2^{nd} stage SCI can be updated with a new field to indicate the request for location information update. Alternatively, the request for the location information can be implicitly performed by setting one or more fields in the 1^{st} or 2^{nd} stage SCI to pre-configured values. In addition, the request can be targeted towards one (i.e., unicast) or more UEs (i.e., groupcast) or to all neighboring UEs (broadcast). For example, in case of groupcast, a clusterhead may periodically send a request to update the locations of all its cluster members so that they can be reached when needed. The request for UE locations can also target UEs within a specific distance or zone/subzone. For example, the request can indicate the Tx UE location and a specific range within which UEs are expected to provide their location information. In this case, the range field in the 2^{nd} stage SCI format 2-B can be reused. The request can also carry additional information to reduce the overhead or to increase the validity of the location information, such as by requesting a future projected location. For example, an update to one or both of the zone ID and the subzone ID or a projected location rather than the current location may be requested. The trigger for transmitting the location information can be based on pre-defined conditions, such as when entering a new zone or subzone, and can be enabled or disabled by resource pool configuration.

To convey the subzone location to its neighbors, a UE can use a bitmap whereby setting a specific bit indicates that the UE's location is in the corresponding subzone. In addition, the size of the subzone, the number of subzones per zone, and the bitmap size can all be configured per resource pool. To reduce the overhead with the bitmap transmission, particularly when the number of subzones is large, a UE may be required to indicate its differential location with respect to the previous subzone. For example, since it is unlikely that the UE's location will significantly differ between two subsequent location updates, a UE can use a three-bit field to indicate one of the following possible changes to its subzone index {−3,−2,−1,0, 1, 2, 3, 4}.

In some cases, the location update message can be lost (e.g., due to interference or low signal to noise and interference ratio (SINR)). Subsequently, the Tx UE will not be able to update the location of its target UEs. To address this instance, the history information is considered to build a trajectory. Accordingly, the Tx UE can anticipate the location of the neighboring target UEs until a new location update becomes available. For example, when the subzones are allocated along a straight line, if a target UE's last known three updates were subzones 2, 3, 4, but the last update was lost, the Tx UE can anticipate that the target UE should be in subzone 5. Similarly, if the last known 3 updates were reporting the same subzone, the Tx UE can anticipate that the target UE is not moving and thus presume that the target UE is in the same subzone. However, since this location is anticipated, it may be unreliable long-term. Thus, the location is either removed once a new update becomes available so as not to impact future projections or is considered to be valid for a shorter duration when compared to regular location updates from the target UE.

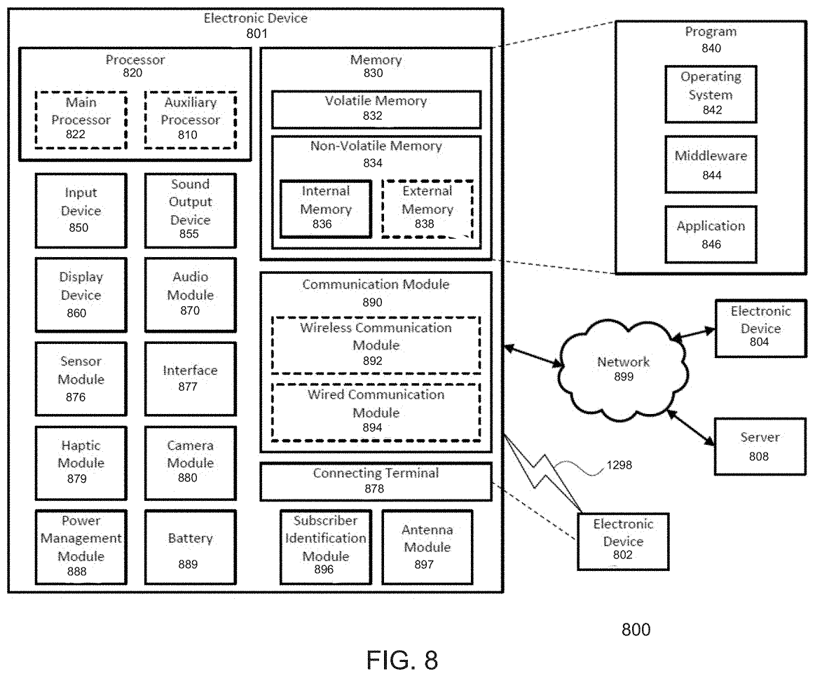

FIG. 8 is a block diagram of an electronic device in a network environment 800, according to an embodiment. Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 840, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 894. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute, for example, software (e.g., a program 840) to control at least one other component (e.g., a hardware or a software component) of the electronic device 801 coupled with the processor 820 and may perform various data processing or computations. As at least part of the data processing or computations, the processor 820 may load a command or data received from another component (e.g., the sensor module 846 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application).

The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes.

The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

While the present disclosure has been described with reference to certain embodiments, various changes may be made without departing from the spirit and the scope of the disclosure, which is defined, not by the detailed description and embodiments, but by the appended claims and their equivalents.

What is claimed is:

1. A method, comprising:
identifying, for a transmission between a user equipment (UE) and one or more neighboring UEs, one or more interfering UEs of the one or more neighboring UEs by determining potential collisions between candidate resources identified by the UE and resources selected by the one or more neighboring UEs based on beam information, location information, measured signal strength, and resource reservation information; and
excluding resources reserved by the one or more interfering UEs from a resource selection window.

2. The method of claim 1, further comprising:
excluding the resources reserved by the one or more interfering UEs by determining whether a reservation power is above a priority-based threshold, and
selecting a resource from candidate resources remaining after the exclusion.

3. The method of claim 2, wherein the beam information, location information of the UE, and resource reservation information are obtained from sidelink control information (SCI) on a physical sidelink control channel (PSCCH) or from a basic safety message.

4. The method of claim 3, further comprising:
indicating, in the transmission, a transmission direction, the beam information, and the location information, to the one or more neighboring UEs receiving the transmission.

5. The method of claim 1,
wherein the potential collisions are avoided by performing a mode 2 resource selection procedure and including the location and beam information from the one or more neighboring UEs to estimate the interference on subchannels and slots within the resource selection window and exclude the resources reserved by the one or more interfering UEs from the set of candidate resources.

6. The method of claim 5,
wherein the transmission is sent to the one or more neighboring UEs on non-excluded resources by the mode 2 resource selection procedure while resources reserved by the one or more interfering UEs are excluded from the transmission, and
wherein the one or more interfering UEs are identified by considering areas around UEs as zones.

7. The method of claim 6,
wherein an exclusion zone is defined in at least one of the areas of the zone, and
wherein the one or more interfering UEs are further identified by being within the exclusion zone or having at least one target UE within the exclusion zone.

8. The method of claim 7,
wherein, within the exclusion zone, the resources reserved by the one or more interfering UEs are excluded from the resource selection window when selecting the resources from the candidate resources.

9. The method of claim 7,
wherein the zone is divided into a number of subzones that are configured per resource pool and are indicated in the SCI.

10. A user equipment (UE), comprising:
at least one processor; and
at least one memory operatively connected with the at least one processor, the at least one memory storing instructions, which when executed, instruct the at least one processor to perform a method by:
identifying, for a transmission between a user equipment (UE) and one or more neighboring UEs, one or more interfering UEs of the one or more neighboring UEs by determining potential collisions between candidate resources identified by the UE and resources selected by the one or more neighboring UEs based on beam information, location information, measured signal strength, and resource reservation information; and
excluding resources reserved by the one or more interfering UEs from a resource selection window
excluding resources reserved by the one or more interfering UEs from a resource selection window.

11. The UE of claim 10,
wherein the processor further excludes the resources reserved by the one or more interfering UEs by determining whether a reservation power is above a priority-based threshold and selects a resource from candidate resources remaining after the exclusion.

12. The UE of claim 11,
wherein the beam information, location information of the UE, and resource reservation information are obtained from sidelink control information (SCI) on a physical sidelink control channel (PSCCH) or from a basic safety message.

13. The UE of claim 12,
wherein the processor further indicates, in the transmission, a transmission direction, the beam information, and the location information, to the one or more neighboring UEs receiving the transmission.

14. The UE of claim 12,
wherein the potential collisions are avoided by performing a mode 2 resource selection procedure and including the beam information from the one or more neighboring UEs to estimate the interference on subchannels and slots within the resource selection window and exclude the resources reserved by the one or more interfering UEs from the set of candidate resources.

15. The UE of claim 14,
wherein the transmission is sent to the one or more neighboring UEs on non-excluded resources by the mode 2 resource selection procedure while resources reserved by the one or more interfering UEs are excluded from the transmission, and
wherein the one or more interfering UEs are identified by considering areas around UEs as zones.

16. The method of claim 15,
wherein an exclusion zone is defined in at least one of the areas of the zone, and
wherein the one or more interfering UEs are further identified by being within the exclusion zone or having at least one target UE within the exclusion zone.

17. The UE of claim 16,
wherein, within the exclusion zone, the resources reserved by the one or more interfering UEs are excluded from the resource selection window when selecting the resources from the candidate resources.

18. The UE of claim 16,
wherein the zone is divided into a number of subzones that are configured per resource pool and are indicated in the SCI.
